(19) United States
(12) Patent Application Publication
(10) Pub. No.: US 2016/0353133 A1
(43) Pub. Date: Dec. 1, 2016

(54) Dynamic Dependency Breaking in Data Encoding

(71) Applicant: Cisco Technology, Inc., San Jose, CA (US)

(72) Inventor: Thomas James Davies, Surrey (GB)

(21) Appl. No.: 14/726,563

(22) Filed: May 31, 2015

(51) Int. Cl. H04N 19/97; H04N 19/40

(52) U.S. Cl. CPC H04N 19/97; H04N 19/40

(57) ABSTRACT

In one embodiment, a method includes selecting a first video encoding task of the plurality of video encoding tasks, the first video encoding task having a first dependency upon a second video encoding task of the plurality of video encoding tasks. The method includes determining whether to break the first dependency and performing the first video encoding task based on the determination of whether to break the first dependency.

### TECHNICAL FIELD

The present disclosure relates generally to data encoding and decoding, and in particular, to systems, methods and apparatuses enabling encoding and decoding of data with dynamic dependencies.

### BACKGROUND

The ongoing development of video encoding technology often involves increasing the speed and efficiency of the encoding process and/or increasing the compression rate of the encoded video data. Various tradeoffs may be made to increase the efficiency of the encoding process at the expense of compression rate or to increase the compression rate at the expense of the efficiency of the encoding process.

Where one video encoding task may be performed based on the result of performing another video encoding task, one method of video encoding on a computing device is to delay performance of the video task until performance of the other task is complete. However, this may not be desirable for low-delay applications, such as video conference or live video streaming, or where the computing device has insufficient speed to perform the tasks serially. Another method of video encoding is to perform the video encoding task independent of the result of performing the other video encoding task, for example by using multiple work units (e.g., processors, cores, threads, etc.) of a computing device. However, this may not be desirable as ignoring such dependency may decrease coding efficiency and/or the compression rate of the encoded video data.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of a data network in accordance with some implementations.

FIG. 2 is a flowchart representation of a method of dynamically breaking dependencies in accordance with some implementations.

FIG. 3 is a flowchart representation of a method of encoding video in accordance with some implementations.

FIG. 4 is a diagram of a frame of video illustrating an order of performing video encoding tasks in accordance with some implementations.

FIG. 5A is a block diagram of a data transmission with two messages, each including data indicative of the result of a video encoding task and a flag indicative of whether a dependency of the video encoding task was broken in accordance with some implementations.

FIG. 5B is a block diagram of a data transmission with three messages, one of which includes data indicative of a frame parameter in accordance with some implementations.

FIG. 5C is a block diagram of a data transmission with three messages, one of which includes a number of flags in accordance with some implementations.

FIG. 5D is a block diagram of a data transmission including three messages, one of which includes encoded determination data in accordance with some implementations.

FIG. 6 is a flowchart representation of a method of decoding video data in accordance with some implementations.

FIG. 7 is a block diagram of a computing device in accordance with some implementations.

FIG. 8 is a block diagram of another computing device in accordance with some implementations.

In accordance with common practice various features shown in the drawings may not be drawn to scale, as the dimensions of various features may be arbitrarily expanded or reduced for clarity. Moreover, the drawings may not depict all of the aspects and/or variants of a given system, method or apparatus admitted by the specification. Finally, like reference numerals are used to denote like features throughout the figures.

### DESCRIPTION OF EXAMPLE EMBODIMENTS

Numerous details are described herein in order to provide a thorough understanding of the illustrative implementations shown in the accompanying drawings. However, the accompanying drawings merely show some example aspects of the present disclosure and are therefore not to be considered limiting. Those of ordinary skill in the art will appreciate from the present disclosure that other effective aspects and/or variants do not include all of the specific details of the example implementations described herein. While pertinent features are shown and described, those of ordinary skill in the art will appreciate from the present disclosure that various other features, including well-known systems, methods, components, devices, and circuits, have not been illustrated or described in exhaustive detail for the sake of brevity and so as not to obscure more pertinent aspects of the example implementations disclosed herein.

### Overview

Various implementations disclosed herein include apparatuses, systems, and methods for encoding data. For example, in some implementations, a method includes selecting a first video encoding task of the plurality of video encoding tasks, the first video encoding task having a first dependency upon a second video encoding task of the plurality of video encoding tasks, determining whether to break the first dependency, and performing the first video encoding task based on the determination of whether to break the first dependency. In one implementation, the first video encoding task is performed based on a result of performing the second video encoding task in response to determining not to break the first dependency or the first video encoding task is performed independent of the result of performing the second video encoding task in response to determining to break the first dependency.

In other implementations, a method includes receiving first data indicative of a result of performing a first video encoding task, receiving second data indicative of a result of performing a second video encoding task, receiving third data indicative of whether the first video encoding task was performed based on the result of performing the second video encoding task, and performing, using the first data, a first video decoding task associated with the first video encoding task. In one implementation, the first video decoding task is performed based on the second data in response to the third data indicating that the first video encoding task was performed based on the result of performing the second video encoding task or the first video decoding task is performed independent of the second data in response to the third data indicating that the first video encoding task was not performed based on the result of performing the second video encoding task.

### Example Embodiments

A job to be performed by a computer including one or more processors may include a number of tasks. It may be desirable to perform multiple tasks simultaneously such that different tasks are performed by different work units (e.g., processors, cores, threads, etc.) in parallel. However, this may be frustrated by the fact that performance of one of the tasks may depend on a result generated by performing another one of the tasks.

Where performance of a first task necessarily depends on a result generated by performance of a second task, the first task may be said to have an unbreakable dependency upon the second task. Where performance of a first task optionally depends on a result generated by performance of a second task, the first task may be said to have a breakable dependency upon the second task. If the dependency is unbroken, the second task is performed based on a result of performing the second task, whereas if the dependency is broken, the first task is performed independently of the result of performing the second task.

For example, a job to encode raw video data may include a number of video encoding tasks having dependencies upon other video encoding tasks. Video encoding dependencies may arise in a number of ways. In some implementations, determined data elements are used to predict other data elements. For example, a motion vector for a region may be predicted using motion vectors in neighboring regions and only the difference encoded. In some implementations, data element values are used to affect the way that other data elements are encoded. For example, statistical contexts for entropy encoding of a region may be used for entropy encoding of another region. In some implementations, data elements are combined together in a common process, such as deblocking filtering, where pixels in each region are modified in part on the basis of values of pixels in another region.

One method of handling dependencies is to delay performance of a task having a dependency on another task until performance of the other task is complete. However, this may not be desirable for low-delay applications, such as video conference or live video streaming, and it may not perform encoding fast enough for real-time applications even if low delay is not required. Another method of handling dependencies is to break breakable dependencies. However, this may not be desirable as breaking dependencies may decrease coding efficiency and/or the compression rate of the encoded video data.

In some implementations, the raw video data includes a number of frames and a frame is partitioned into a number of independent regions as specified by a video encoding standard. In some implementations, the independent regions are tiles or slices of the frame. Tiles consisting of pixels may be partitioned into blocks, each block of pixels may be predicted, transformed, the transform coefficients may be ordered and quantized, and some form of entropy coding (variable length coding or arithmetic coding) may be used to represent the series of quantized transform coefficients of each block and the associated metadata encoding prediction modes, motion data, block sizes, partition structures, and so on. The entropy coding method may include Context-based Adaptive Binary Arithmetic Coding (CABAC) or Context Adaptive Variable Length Coding (CAVLC). Dependencies of video encoding tasks associated with a region upon video encoding tasks associated with the same region are unbroken, potentially introducing delay. Dependencies of video encoding tasks associated with a first region upon video encoding tasks associated with a second region are invariably broken, potentially reducing the compression rate of the encoded video data.

In order to reduce the amount of delay, the size of the independent regions may be reduced to correspondingly reduce the computational complexity of one or more associated video encoding tasks. Each region may be associated with multiple video encoding tasks, such as motion estimation, motion compensation, mode decision, transform an quantization, loop filtering, or other video encoding tasks. Because the computation complexity of the associated video encoding tasks varies and it does not necessarily take an equal amount of time to perform each task, there may be significantly more independent regions than work units in order to maintain throughput by avoiding work units idling due to a lack of video encoding tasks ready to be performed. This may significantly impact the compression rate of the encoded video data.

In some implementations, as described in detail herein, an encoder dynamically determines whether to break dependencies. In some implementations, the encoder selects a video encoding task to perform and, once the video encoding task is selected, determines whether to break one or more dependencies of the video encoding task. In some implementations, the encoder performs the video encoding task based on the determination. In some implementations, the determination to break a dependency upon a task is made based on whether the task has been completed and is known to have been completed via inter-process signaling.

Dependencies may or may not be broken across tile boundaries adaptively according to the determinations of the encoder. Further, dependencies can change frame-by-frame. As such dependency breaking is dynamic, in some implementations, the encoder transmits flags for a tile signaling which dependencies associated with the tile are broken and which are not.

In some implementations, the encoder selects video encoding tasks for performance to reduce the number of broken dependencies (and, therefore, increase the compression rate of the encoded video data) without introducing additional delay. For example, in some implementations, the encoder selects video encoding tasks according to a non-raster order. As another example, in some implementations, the encoder selects a video encoding task having no unresolved dependencies, either because the video encoding task does not have a dependency or because its dependencies have been resolved, e.g., the results of performing other video encoding tasks upon which the video encoding task has dependencies are available and are known to be available by way of an inter-process signaling method. As another example, in some implementations, the encoder selects a video encoding task upon which a large number of other video encoding tasks have dependencies.

In some implementations, the encoder determines whether to break one or more dependencies of the video encoding task to reduce the overall number of broken dependencies without introducing additional delay. For example, in some implementations, the encoder determines whether to break a dependency upon another video encoding task based on whether a result of performing the other video encoding task is available, e.g., whether performance of the other video encoding task has been completed. As another example, in some implementations, the encoder determines whether to break a dependency upon another video encoding task based on a relative location in a frame associated with the other video encoding task. In some implementations, an encoder determines to break the dependency when the other video encoding task is associated with a different quadrant of the frame than that of the video encoding task in order to increase parallelism at the decoder.

In some implementations, the encoder generates one or more flags indicative of which, if any, of one or more dependencies are broken. The flags may be transmitted to a decoder with the result of performing the video encoding task. In some implementations, the flags for multiple video encoding tasks are transmitted together in a single message, which may be encoded prior to transmission. In some implementations, the flags for multiple video encoding tasks are transmitted separately with the results of performing each of the multiple video encoding tasks.

Although aspects of the invention are described below with respect to video encoding, it is to be appreciated that aspects of the inventions may be used with other types of media encoding (such as audio encoding), other types of data encoding, or any other job including one or more tasks.

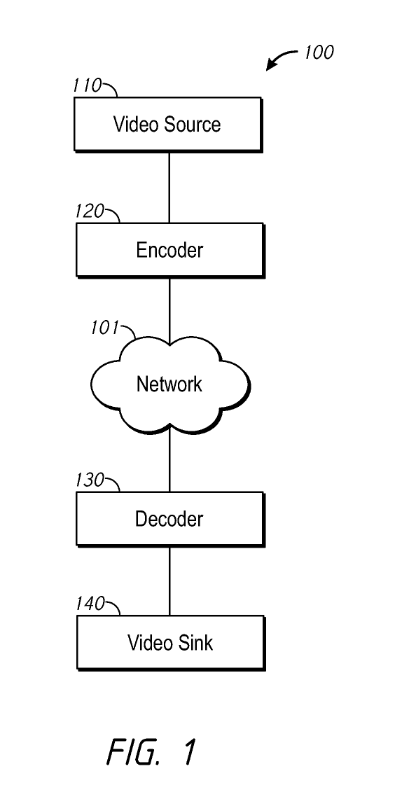

FIG. 1 is a block diagram of a data network 100 in accordance with some implementations. The data network 100 includes a video source 110 coupled to an encoder 120. The encoder 120 receives raw video data from the video source 110 and encodes the raw video data into encoded video data. In some implementations, the video source 110 includes a camera that generates the raw video data. In some implementations, the video source 110 includes a memory that stores the raw video data. The encoder 120 may be implemented as hardware, firmware, software, or any combination thereof. In some implementations, the encoder 120 is implemented by a processor executing instruction from a memory to encode the raw video data. In some implementations, the encoder 120 includes, or controls, a plurality of work units (e.g., processing units or processing cores) for performing video encoding tasks associated with encoding the raw video data.

The encoder 120 is coupled, via a network 101, to a decoder 130. The network 101 may include any public or private LAN (local area network) and/or WAN (wide area network), such as an intranet, an extranet, a virtual private network, and/or portions of the Internet. In some implementations, the encoder 120 transmits the encoded video data to the decoder 130 via the network 101. In some implementations, the encoder 120 transmits the encoded video data as a plurality of packets in accordance with an Internet protocol, e.g., IPv4 or IPv6. In some implementations, the encoder 120 streams the encoded video data to the decoder 130 by which portions of the encoded video data are transmitted to the decoder 130 while the encoder 120 encodes additional portions of the raw video data.

The decoder 130 receives the encoded video data, via the network 101, from the encoder 120 and decodes the encoded video data to produce decoded video data. In some implementations, the decoded video data may be substantially identical to the raw video data, as in the case of a lossless compression. In some implementations, the decoded video data is a lossy version of the raw video data. Like the encoder 120, the decoder 130 may be implemented as hardware, firmware, software, or any combination thereof. In some implementations, the decoder 130 is implemented by a processor executing instruction from a memory to decode the encoded video data.

The decoder 130 is coupled to a video sink 140 that can consume the decoded video data. In some implementations, the video sink 140 includes a display device (such as a television, computer monitor, or mobile device screen) that displays the decoded video data to a user. In some implementations, the video sink 140 may be a memory that stores the decoded video data.

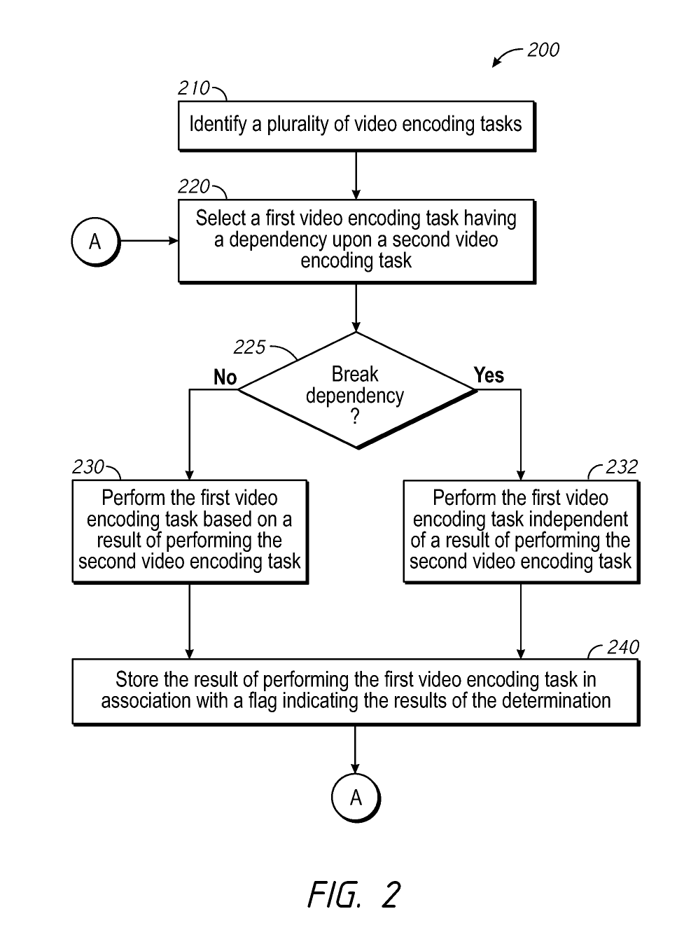

FIG. 2 is a flowchart representation of a method 200 of dynamically breaking dependencies in accordance with some implementations. In some implementations (and as detailed below as an example), the method 300 may be performed by an encoder, such as the encoder 120 of FIG. 1. In some implementations, the method 200 may be performed by processing logic, including hardware, firmware, software, or a combination thereof. In some implementations, the method 200 may be performed by a processor executing code stored in a non-transitory computer-readable medium (e.g., a memory). Briefly, the method 200 includes selecting a video encoding task, determining whether to break a dependency of the video encoding task, and performing the video encoding task based on the determination.

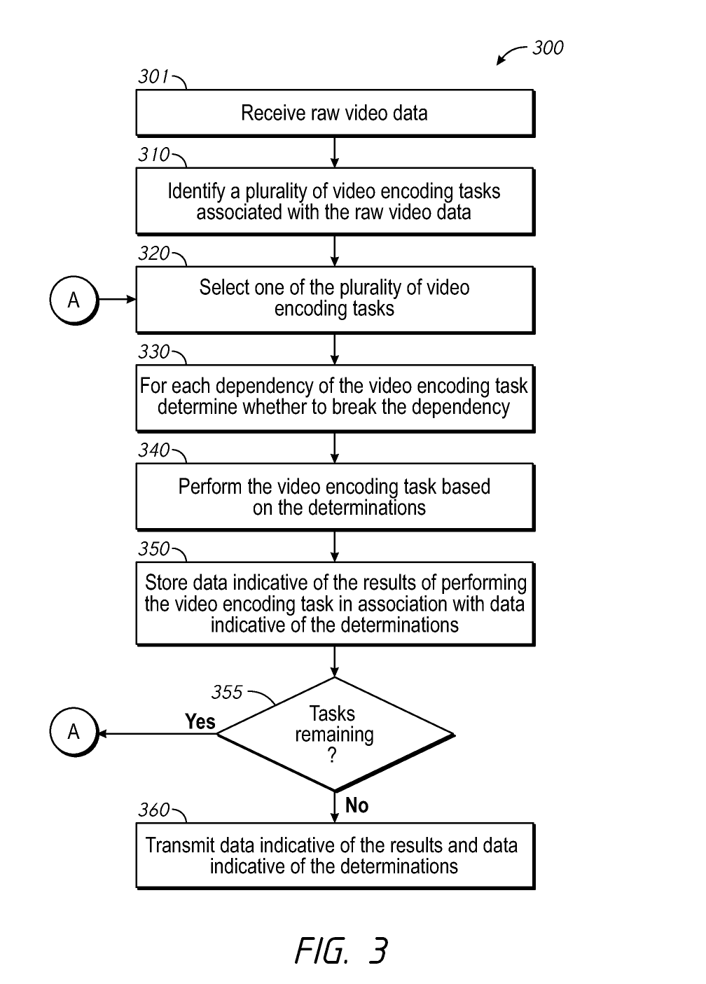

The method 200 begins, at block 210, with the encoder identifying a plurality of video encoding tasks. In some implementations, the encoder receives raw video data and itself determines the plurality of video encoding tasks based on the received raw video data. In some implementations, the encoder receives data indicative of the plurality of video encoding tasks to be performed. Examples of video encoding tasks are described in detail below with respect to block 310 of FIG. 3.

At block 220, the encoder selects a first video encoding task of the plurality of video encoding tasks having a dependency upon a second video encoding task of the plurality of video encoding tasks. In some implementations, the encoder selects, as the first video encoding task, a next video encoding task in a predefined order. In some implementations, the encoder dynamically selects the first video encoding task to reduce the number of broken dependencies in performing the plurality of video encoding tasks.

At block 225, the encoder determines whether to break the dependency. The encoder may determine whether to break the dependency based on any of a number of factors. In some implementations, the encoder determines whether to break the dependency based on whether a result of performing the second video encoding task is available, e.g., whether performance of the second video encoding task has been completed. For example, in some implementations, the encoder determines to break the dependency if the result is unavailable and determines not to break the dependency if the result is available.

If the encoder determines (in block 225) not to break the dependency, the method 200 proceeds to block 230 where the encoder performs the first video encoding task based on a result of performing the second video encoding task. If the encoder determines (in block 225) to break the dependency, the method proceeds to block 232 where the encoder performs the first video encoding task independent of a result of performing the second encoding task. It is to be appreciated that performing the first video encoding task independent of the result of performing the second video encoding task may be performed even when the result of performing the second video encoding task has not been generated.

From blocks 230 and 232, the method 200 proceeds to block 240 where the encoder stores the result of performing the first video encoding task in association with a flag indicating the result of the determination of whether to break the dependency. In some implementations, the flag is, for example, a ‘0’ if the encoder determined not to break the dependency or a ‘1’ if the encoder determined to break the dependency. Thus, in some implementations, the encoder stores the result of performing the first video encoding task based on a result of performing the second video encoding task in association with a flag having a first value or stores the result of performing the first video encoding task independent of a result of performing the second video encoding task in association with a flag having a second value.

From block 240, the method 200 returns to block 220 where the encoder selects another video encoding task. In some implementations, the method 200 iterates until all of the plurality of video encoding tasks have been performed.

FIG. 3 is a flowchart representation of a method 300 of encoding video in accordance with some implementations. In some implementations (and as detailed below as an example), the method 300 may be performed by an encoder, such as the encoder 120 of FIG. 1. In some implementations, the method 300 may be performed by processing logic, including hardware, firmware, software, or a combination thereof. In some implementations, the method 300 may be performed by a processor executing code stored in a non-transitory computer-readable medium (e.g., a memory). Briefly, the method 300 includes receiving raw video data, performing each of a plurality of video encoding tasks associated with the raw video data based on determinations of whether to break dependencies of the video encoding tasks, and transmitting data indicative of the results of performing the plurality of video encoding tasks and data indicative of the determinations.

The method 300 begins, at block 301, with the encoder receiving raw video data. In some implementations, the encoder receives the raw video data from a video source (such as the video source 110 of FIG. 1) which may include a camera that generates the raw video data or a memory that stores the raw video data. In some implementations, the encoder receives the raw video data via a network (such as the network 101 of FIG. 1).

At block 310, the encoder identifies a plurality of video encoding tasks associated with the raw video data. In some implementations, identifying the video encoding tasks also includes identifying dependencies of the video encoding tasks upon others of the video encoding tasks (and whether the dependencies are breakable or unbreakable). In some implementations, the video encoding tasks include encoding of a region of a frame of the raw video data, e.g., a block, a macroblock, a tile, a slice, or any other spatial region. In some implementations, the video encoding tasks includes multiple video encoding tasks for the same region of a frame. For example, the video encoding tasks may include a first task for the first region of mode selection (e.g., between intra-frame coding, inter-frame coding, or independent coding), a second task for the first region of intra-frame, inter-frame, or independent coding, and a third task for the first region of entropy encoding. The second task may have a breakable dependency on the first task, where if the dependency is not broken, performing the second task includes performing the mode selected by performing the first task and if the dependency is broken, performing the second task includes performing a default mode of coding. The second task may have other dependencies on other tasks. Similarly, the video encoding tasks may include a fourth task for a second region of mode selection, a fifth task for the second region of intra-frame, inter-frame, or independent coding, and a sixth task for the second region of entropy encoding. The sixth task may have a breakable dependency on the third task, where if the dependency is not broken, performing the sixth task includes performing entropy encoding using the arithmetic coding contexts determined at the end of performing the third task and, if the dependency is broken, performing the sixth task includes performing entropy encoding using default contexts. In some implementations, one or more of the video encoding tasks includes sub-tasks which may have breakable or unbreakable dependencies upon other sub-tasks of the video encoding task.

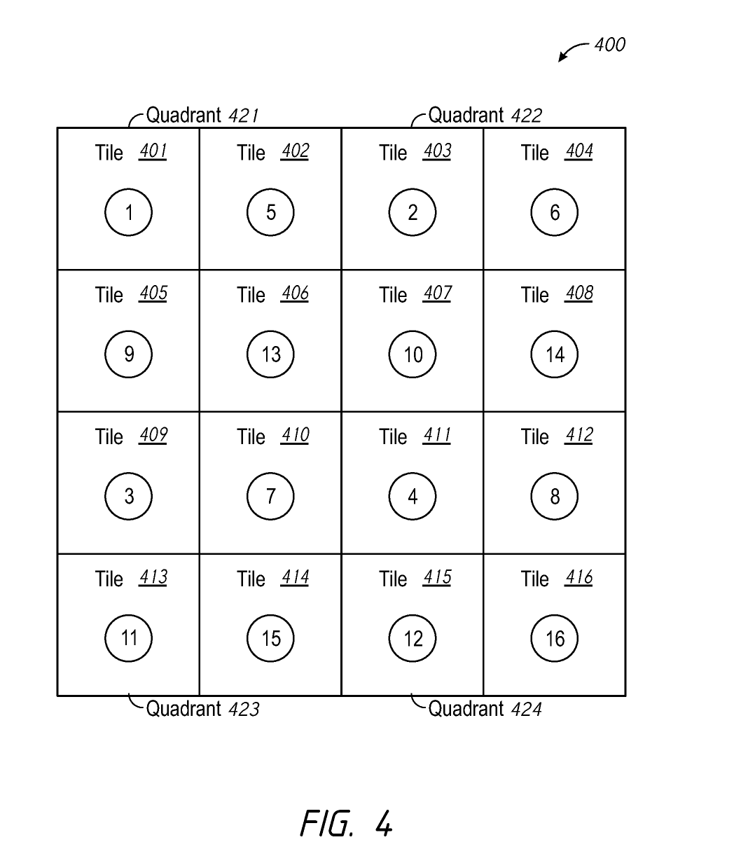

At block 320, the encoder selects one of the plurality of video encoding tasks. In some implementations, the encoder selects, as the video encoding task, a next video encoding task in a predefined order. To that end, identifying the plurality of video encoding tasks (in block 310) includes determining an order of the video encoding tasks in some implementations. In some implementations, determining the order of the video encoding tasks includes accessing an order stored in memory (e.g., as defined by a standard). The order may be a raster order or a non-raster order. Example orders that may be defined by a standard are described in detail below with respect to FIG. 4.

In some implementations, determining the order of the video encoding tasks includes generating an order based on the video encoding tasks. In some implementations, the encoder generates the order so as to reduce the probability of breaking dependencies in performing the plurality of video encoding tasks. To that end, in some implementations, the encoder determines, for each of the plurality of video encoding tasks, a number of other video encoding tasks having a dependency upon the video encoding task and generates the order based on the numbers. For example, in some implementations, the encoder generates the order such that video encoding tasks with a large number of other video encoding tasks having a dependency upon the video encoding task are performed before video encoding tasks with a small number of other video encoding tasks having a dependency upon the video encoding task.

In some implementations, the encoder selects the video encoding task on-the-fly or out-of-order, allowing time for dependencies of other video encoding tasks to be resolved. For example, in some implementations, the encoder selects the video encoding task based on determining that the video encoding task has no unresolved dependencies. As another example, in some implementations, the encoder determines, for each of the plurality of video encoding tasks, a number of unresolved dependencies had by the video encoding task, and selects the video encoding task having the smallest number. Similarly and conversely, in some implementations, the encoder determines, for each of the plurality of video encoding tasks, a number of resolved dependencies had by the video encoding task, and selects the video encoding task with the greatest number.

In some implementations, the encoder selects the video encoding tasks so as to attempt to resolve dependencies for other video encoding tasks. To that end, in some implementations, the encoder determines, for each of the plurality of video encoding tasks, a number of other video encoding tasks having a dependency upon the video encoding task and selects the video encoding task having the greatest number.

As noted above, in some implementations, the encoder treats various parts of the encoding process for each tile or slice region as separate video encoding tasks. For example, entropy encoding could be a different video encoding task from mode decision. In some implementations, the video encoding tasks are selected (or otherwise ordered) to increase the number of resolved dependencies, both between spatially neighboring regions and between video encoding tasks for the same region.

At block 330, the encoder determines, for each dependency of the video encoding task (if any) whether to break the dependency. The encoder may determine whether to break the dependency based on any of a number of factors. In some implementations, the encoder determines whether to break the dependency upon a video encoding task based on whether a result of performing the video encoding task is available, e.g., whether performance of the video encoding task has been completed. For example, in some implementations, the encoder determines to break the dependency if the result is unavailable and determines not to break the dependency if the result is available. In some implementations, the encoder determines whether to break the dependency upon a video encoding task based on a location in a frame associated with the video encoding task.

In some implementations, the encoder may determine to break a dependency upon a video encoding task even when a result of performing the video encoding task is available. For example, in some implementations, the encoder determines to break the dependency when the video encoding task is associated with a different quadrant of the frame than that of the selected video encoding task in order to increase parallelism at the decoder.

In some implementations, the encoder may determine not to break a dependency upon a video encoding task even when a result of performing the video encoding task is unavailable. For example, in some implementations, the encoder may determine that the coding efficiency achievable by not breaking the dependency outweighs the delay in waiting for the dependency to resolve. Thus, in some implementations, determining whether to break the dependency upon a particular video encoding task includes determining that the result of performing the particular video encoding task is unavailable, determining to wait for the result of performing the second video encoding task to become available, and determining not to break the first dependency in response to the result of performing the particular video encoding task becoming available.

In some implementations, the encoder may determine to break one dependency of the selected video encoding task and not break another dependency of the selected video encoding task. For example, the selected video encoding task may be associated with encoding a tile and may have a first dependency upon a first video encoding task associated with a tile vertically adjacent to the tile and second dependency upon a second video encoding task associated with tile horizontally adjacent to the tile. The encoder may determine to break the first dependency, the second dependency, neither dependency, or both dependencies.

At block 340, the encoder performs the selected video encoding task based on the determinations of whether to break the dependencies. If the encoder determines not to break a particular dependency upon a particular video encoding task, the encoder performs the selected video encoding task based on a result of performing the particular video encoding task. If the encoder determines to break a particular dependency upon a particular video encoding task, the encoder performs the selected video encoding task independent of a result of performing the particular encoding task. It is to be appreciated that performing the selected video encoding task independent of the result of performing the particular video encoding task may be performed even when the result of performing the particular video encoding task has not been generated.

As an example, the selected video encoding task may have two dependencies, a first dependency on a first video encoding task and a second dependency on a second video encoding task. The encoder may determine (in block 330) to break the first dependency and not to break the second dependency. The encoder may (in block 340) perform the selected video encoding task independent of a result of performing the first video encoding task, but based on a result of performing the second video encoding task.

At block 350, the encoder stores data indicative of the result of performing the selected video encoding task in association with data indicative of the determinations of whether to break the dependencies. In some implementations, the encoder stores the data indicative of the result and the data indicative of the determination in a memory, which may include a transmission buffer for near real-time transmission of the encoded video data. In some implementations, the data indicative of the determinations includes one or more flags respectively indicative of the determination of whether to break one or more dependencies of the selected video encoding task.

At block 355, the encoder determines whether there are video encoding tasks remaining to be performed. If so, the method 300 returns to block 320 whether the encoder selects another of the plurality of video encoding tasks. If not, the method 300 continues to block 360 where the encoder transmits data indicative of the results of performing the plurality of video encoding tasks and data indicative of the determinations of whether to break the dependencies.

Although block 360 is described (and illustrated in FIG. 3) as following a decision that there are no video encoding tasks remaining, it is to be appreciated that in some implementations, transmission of data indicative of the results of performing video encoding tasks (and data indicative of the determinations made with respect to breaking dependencies of the those video encoding tasks) occurs simultaneously with the handling of other video encoding tasks as described with respect to blocks 320-350.

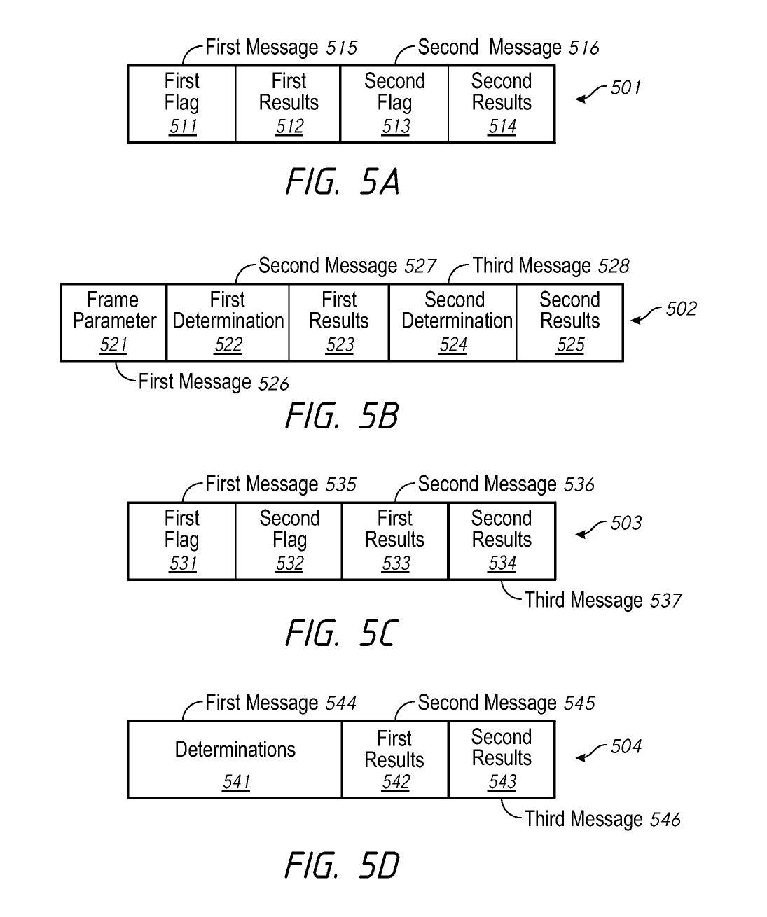

Data indicative of the determinations of whether to break the dependencies may be transmitted with the data indicative of the results in a number of ways. As noted above, in some implementations, the data indicative of the determinations includes one or more flags respectively indicative of determinations of whether to break one or more dependencies. In some implementations, these dependency flags for a particular region are transmitted in a message including the data indicative of the results of performing video encoding tasks associated with that region. For example, in some implementations, dependency flags for a tile are transmitted in a header of a message for the tile and encoded video data for the tile are transmitted in the body of the message. In some implementations, dependency flags for multiple regions (or multiple video encoding tasks) are combined into a single message separate from respective messages including encoded video data for the multiple regions (or results of performing the multiple video encoding tasks). Various signaling schemes are described in detail below with respect to FIG. 5.

In some implementations, data may be transmitted in same order in which it is encoded. In some implementations, data reordered for transmission to reduce decoder latency and add resilience. In some implementations, the geometric order in which data is processed and/or transmitted may change from frame to frame. In some implementations, data is transmitted in slice messages, each slice message including a header indicating which tile the slice message contains and a body including data for a number of tiles that are distributed around the frame.

In some implementations, transmission of the data includes transmitting the data over a network. To that end, in some implementations, the data indicative of the results and the data indicative of the determinations are transmitted as a number of Internet protocol (IP) packets. In some implementations, the packets may not correspond to the messages described above. Thus, the messages may be packetized such that multiple messages are transmitted in a single packet or a single message may be transmitted over multiple packets.

FIG. 4 is a diagram of a frame 400 of video illustrating an order of performing video encoding tasks in accordance with some implementations. The frame 400 includes sixteen tiles 401-416 arranged into four quadrants 421-424. Each tile may be associated with a single video encoding task or multiple video encoding tasks. For example discussion, it will be assumed that each tile is associated with a single video encoding task, which may include multiple video encoding sub-tasks. Some of the video encoding tasks may have dependencies upon others of the video encoding tasks. For example, the video encoding task associated with tile 402 may have a dependency upon a video encoding task associated with tile 401. As another example, the video encoding task associated with tile 406 may have dependencies upon video encoding tasks associated with tile 402 and tile 405.

The order of performing the video encoding tasks may affect which dependencies are broken. This may be particularly true in an encoder with multiple work units (e.g., a processor with multiple processing cores). In some implementations, the video encoding tasks are performed in raster order, e.g., beginning with the video encoding task associated with tile 401, followed by the video encoding task associated with tile 402, followed by the video encoding task associated with tile 403, followed by the video encoding task associated with tile 404, followed by the video encoding task associated with tile 405, followed by the video encoding task associated with tile 406, etc.

To begin encoding the frame 400, in some implementations, a first work unit is employed to perform the video encoding task associated with tile 401 and a second work unit is employed to perform the video encoding task associated with tile 402. Because the video encoding task associated with tile 402 has a dependency upon the video encoding task associated with tile 401, the second work unit may delay processing or break the dependency.

In some implementations, the video encoding tasks are performing in a non-raster order, such as that illustrated by the numbered circles in FIG. 4. FIG. 4 illustrates an order beginning with the video encoding task associated with tile 401, followed by the video encoding task associated with tile 403, followed by the video encoding task associated with tile 409, followed by the video encoding task associated with tile 411, followed by the video encoding task associated with tile 402, followed by the video encoding task associated with tile 404, etc. In such an order, distance between tiles associated adjacent video encoding tasks in the task order is increased, thereby increasing the proportion of resolved dependencies.

To begin encoding the frame 400, in some implementations, a first work unit is employed to perform the video encoding task associated with tile 401 and a second work unit is employed to perform the video encoding task associated with tile 403. Because the video encoding task associated with tile 403 may have a dependency upon the video encoding task associated with tile 402, the second work unit may delay processing or break the dependency. However, such a break may be advantageous for decoding parallelism.

By selectively breaking dependencies (and signaling such selection using dependency flags in the video stream), decoder parallelism is potentially reduced. For example, increasing the number of unbroken dependencies may reduce opportunities for the decoder to decode in parallel and decode a higher resolution than it otherwise could.

In FIG. 4, dependencies across boundaries of the quadrant 421-424 (bold lines) are unlikely to be met as tasks associated with tiles in different quadrants would have dependencies on those later in the order. Therefore, in some implementations, these dependencies can be guaranteed to be broken, as they may be unlikely to be unbroken, and four-way parallelism can still be signaled to the decoder in such circumstances. Thus, in some implementations, an encoder may determine to break a dependency upon a video encoding task based on the unavailability of a result of performing the video encoding task and/or based on the video encoding task being associated with a tile in a different quadrant than a tile being processed.

FIG. 5A is a block diagram of a data transmission 501 with two messages, each including data indicative of the result of a video encoding task and a flag indicative of whether a dependency of the video encoding task was broken in accordance with some implementations. The data transmission 501 includes a first message 515 including a first flag 511 indicative of whether a dependency of a first video encoding task was broken during an encoding process and first data 512 indicative of the result of performing the first video encoding task. The data transmission 501 further includes a second message 516 including a second flag 513 indicative of whether a dependency of a second video encoding task was broken during the encoding process and second data 514 indicative of the result of performing the second video encoding task. In some implementations, each message 515-516 has a header including the flag 511, 513 and a body including the data 512, 514 indicative of the result. In some implementations, the header includes additional information for the message 515-516, such as a message length or an order of the messages.

FIG. 5B is a block diagram of a data transmission 502 with three messages, one of which includes data indicative of a frame parameter in accordance with some implementations. The data transmission 502 includes a first message 526 including data 521 indicative of frame parameter. In some implementations, the frame parameter includes information regarding tile geometry of a frame, such as a size of a number of tiles or an order in which the tiles were processed. In some implementations, the frame parameter encodes information regarding whether dependencies of video encoding tasks associated with each tile are expected to be broken or unbroken. Thus, in some implementations, only differences to this expectation are transmitted with results of video encoding tasks associated with each tile. Thus, the data transmission 502 includes a second message 527 including first determination data 522 indicative of whether a dependency of a first video encoding task was broken during an encoding process by reference to the frame parameter 521. The second message 527 further includes first data 523 indicative of the result of performing the first video encoding task. Similarly, the data transmission 502 includes a third message 528 including second determination data 524 indicative of whether a dependency of a second video encoding task was broken during the encoding process by reference to the frame parameter 521. The third message 528 further includes second data 525 indicative of the result of performing the second video encoding task. In some implementations, each message 526-528 has a header and a body. In some implementations, the header includes additional information for the message 526-528, such as a message length or an order of the messages. In some implementations, the determination data 522, 524 is included in the header of the messages 527, 528 and the data indicative of the results 523, 525 is included in the body of the messages 527, 528.

FIG. 5C is a block diagram of a data transmission 503 with three messages, one of which includes a number of flags in accordance with some implementations. The data transmission 503 includes a first message 535 including a first flag 531 indicative of whether a dependency of a first video encoding task was broken during an encoding process and a second flag 532 indicative of whether a dependency of a second video encoding task was broken during the encoding process. The data transmission 503 includes a second message 536 including first data 533 indicative of the result of performing the first video encoding task. The data transmission 503 includes a third message 537 including second data 534 indicative of the result of performing the second video encoding task. In some implementations, each message 535-537 has a header and a body. In some implementations, the header includes additional information for the message 535-537, such as a message length or an order of the messages. In some implementations, the flag 531-532, the first data 533, and the second data 534 are included in the body of their respective messages 535-537.

FIG. 5D is a block diagram of a data transmission 504 including three messages, one of which includes encoded determination data in accordance with some implementations. The data transmission 503 includes a first message 544 including encoded determination data 541 indicative of whether of dependencies of multiple video encoding tasks, including a dependency of a first video encoding task and a dependency of a second video encoding task, were broken during an encoding process. The data transmission 504 includes a second message 545 including first data 542 indicative of the result of performing the first video encoding task. The data transmission 504 includes a third message 546 including second data 543 indicative of the result of performing the second video encoding task. In some implementations, each message 544-546 has a header and a body. In some implementations, the header includes additional information for the message 544-546, such as a message length or an order of the messages. In some implementations, the determination data 541, the first data 542, and the second data 543 are included in the body of their respective messages 544-546.

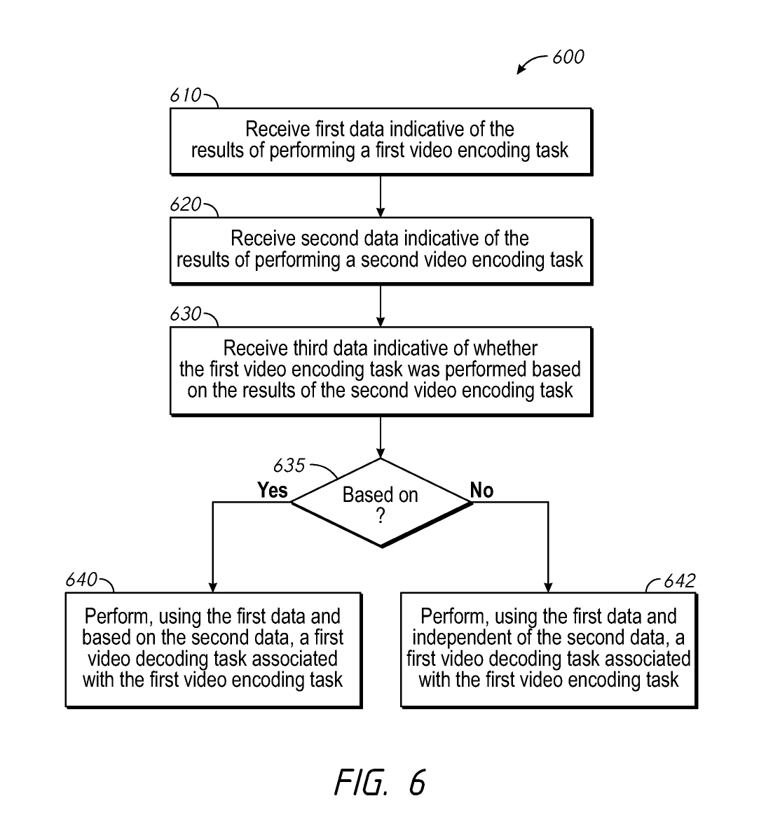

FIG. 6 is a flowchart representation of a method 600 of decoding video data in accordance with some implementations. In some embodiments (and as detailed below as an example), the method 600 may be performed by a decoder, such as the decoder 130 of FIG. 1. In some implementations, the method 600 may be performed by processing logic, including hardware, firmware, software, or a combination thereof. In some implementations, the method 600 may be performed by a processor executing code stored in a non-transitory computer-readable medium (e.g., a memory). Briefly, the method 600 includes receiving first data indicative of the result of performing a first video encoding task, second data indicative of result of performing a second video encoding task, and third data indicative of whether a dependency of the first video encoding task upon the second video encoding task was broken and performing a first video decoding task based on the received data.

The method 600 begins, at block 610, with the decoder receiving first data indicative of the result of performing a first video encoding task. At block 620, the decoder receives data indicative of the result of performing a second video encoding task. At block 630, the decoder receives data indicative of whether the first video encoding task was performed based on the result of performing the second video encoding task. For example, in some implementations, the decoder receives a flag indicating whether a dependency of the first video encoding task upon the second video encoded task was broken or unbroken during an encoding process.

Although described sequentially, it is to be appreciated that blocks 610-630 may be performed sequentially in any order, simultaneously, or overlapping in time. For example, in some implementations, the decoder receives the third data in a header of a message including the first data in the body. In some implementations, the decoder receives the first data, second data, and third data in three different messages.

At block 635, the decoder determines, based on the third data, whether the first video encoding task was performed based on the result of performing the second video encoding task. If so, the method 600 proceeds to block 640 where the decoder performs, using the first data and based on the second data, a first video decoding task associated with the first video encoding task. If not, the method 600 proceeds to block 642 where the decoder performs, using the first data and independent of the second data, the first video decoding task associated with the first video encoding task.

In some implementations, if the third data indicates that the first video encoding task was not performed based on the result of performing the second video encoding task, the decoder may perform the first video decoding task (in block 642) before receiving the second data (in block 620).

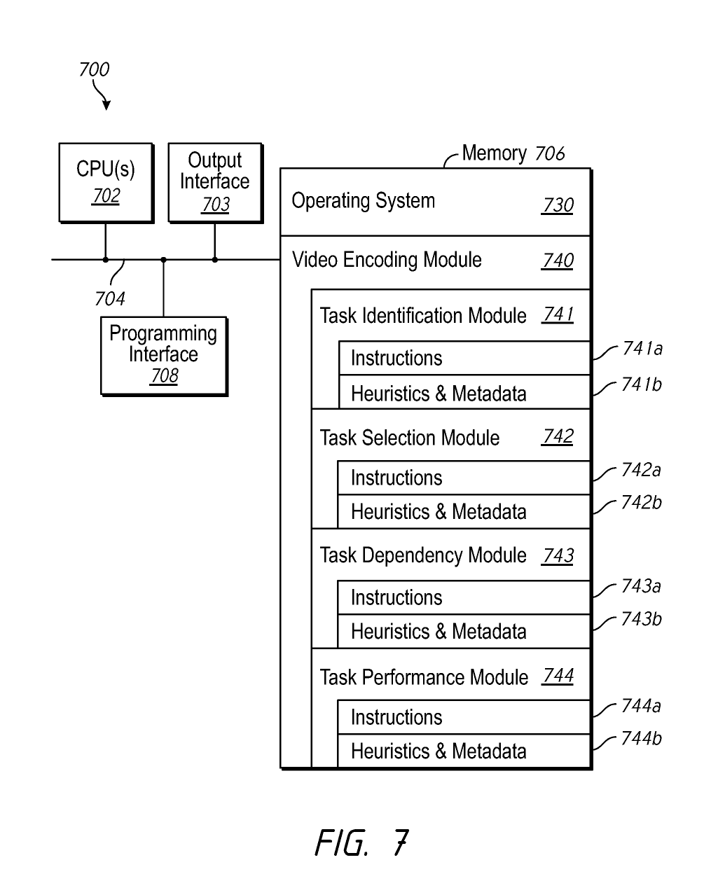

FIG. 7 is a block diagram of a computing device 700 in accordance with some implementations. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 700 includes one or more processing units (CPU's) 702 (e.g., processors), one or more output interfaces 703, a memory 706, a programming interface 708, and one or more communication buses 704 for interconnecting these and various other components.

In some embodiments, the communication buses 704 include circuitry that interconnects and controls communications between system components. The memory 706 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 706 optionally includes one or more storage devices remotely located from the CPU(s) 702. The memory 706 comprises a non-transitory computer readable storage medium. Moreover, in some embodiments, the memory 706 or the non-transitory computer readable storage medium of the memory 706 stores the following programs, modules and data structures, or a subset thereof including an optional operating system 730 and a video encoding module 740. In some embodiment, one or more instructions are included in a combination of logic and non-transitory memory. The operating system 730 includes procedures for handling various basic system services and for performing hardware dependent tasks. In some embodiments, the video encoding module 740 may be configured to perform a number of video encoding tasks to encode raw video data into encoded video data. To that end, the video encoding module 740 includes a task identification module 741, a task selection module 742, a task dependency module 743, and a task performance module 744.

In some embodiments, the task identification module 741 may be configured to identify a plurality of video encoding tasks associated with encoding raw video data into encoded video data. To that end, the task identification module 741 includes a set of instructions 741a and heuristics and metadata 741b. In some embodiments, the task selection module 742 may be configured to select a first video encoding task of the plurality of video encoding tasks having a first dependency upon a second video encoding task of the plurality of video encoding tasks. To that end, the task selection module 742 includes a set of instructions 742a and heuristics and metadata 742b. In some embodiments, the task dependency module 743 may be configured to determine whether to break the first dependency. To that end, the task dependency module 743 includes a set of instructions 743a and heuristics and metadata 743b. In some embodiments, the task performance module 744 may be configured to perform the first video encoding task based on the determination of whether to break the first dependency. In particular, the task performance module 744 may perform the first video encoding task based on a result of performing the second video encoding task in response to the task determination module 743 determining not to break the first dependency or the task performance module 744 may perform the first video encoding task independent of the result of performing the second video encoding task in response to the task determination module 743 determining to break the first dependency. To that end, the task determination module 744 includes a set of instructions 744a and heuristics and metadata 744b.

Although the video encoding module 740, the task identification module 741, the task selection module 742, the task dependency module 743, and the task performance module 744 are illustrated as residing on a single computing device 700, it should be understood that in other embodiments, any combination of the video encoding module 740, the task identification module 741, the task selection module 742, the task dependency module 743, and the task performance module 744 may reside in separate computing devices. For example, each of the video encoding module 740, the task identification module 741, the task selection module 742, the task dependency module 743, and the task performance module 744 may reside on a separate computing device.

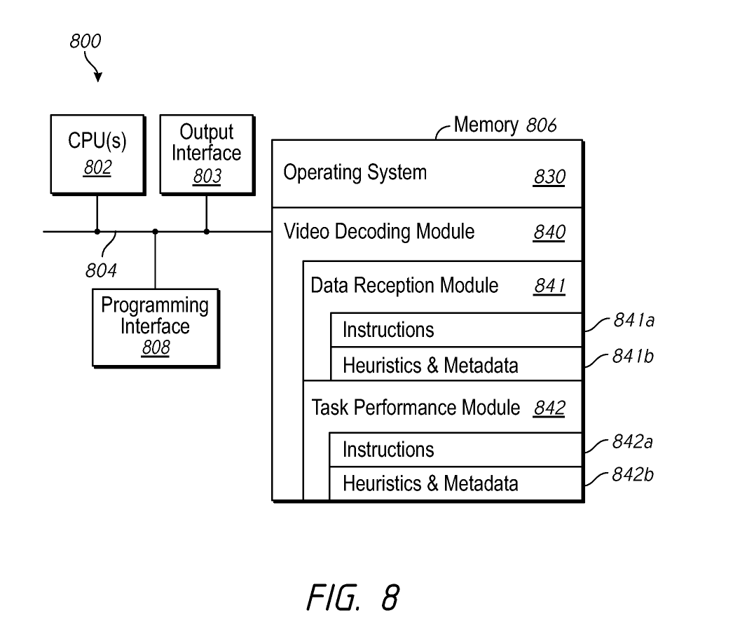

FIG. 8 is a block diagram of another computing device 800 in accordance with some implementations. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 800 includes one or more processing units (CPU's) 802 (e.g., processors), one or more output interfaces 803, a memory 806, a programming interface 808, and one or more communication buses 804 for interconnecting these and various other components.

In some embodiments, the communication buses 804 include circuitry that interconnects and controls communications between system components. The memory 806 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806 comprises a non-transitory computer readable storage medium. Moreover, in some embodiments, the memory 806 or the non-transitory computer readable storage medium of the memory 806 stores the following programs, modules and data structures, or a subset thereof including an optional operating system 830 and a video decoding module 840. In some embodiment, one or more instructions are included in a combination of logic and non-transitory memory. The operating system 830 includes procedures for handling various basic system services and for performing hardware dependent tasks. In some embodiments, the video decoding module 840 may be configured to perform a number of video decoding tasks to decode encoded video data into decoded video data. To that end, the video decoding module 840 includes a data reception module 841 and a task performance module 842.

In some embodiments, the data reception module 841 may be configured to receive first data receiving first data indicative of a result of performing a first video encoding task, receive second data indicative of a result of performing a second video encoding task, and receive third data indicative of whether the first video encoding task was performed based on the result of performing the second video encoding task. To that end, the data reception module 841 includes a set of instructions 841a and heuristics and metadata 841b. In some embodiments, the task performance module 842 may be configured to perform, using the first data, a first video decoding task associated with the first video encoding task. In particular, the task performance module 842 may perform the first video decoding task based on the second data in response to the third data indicating that the first video encoding task was performed based on the result of performing the second video encoding task or may perform the first video decoding task independent of the second data in response to the third data indicating that the first video encoding task was not performed based on the result of performing the second video encoding task. To that end, the task selection module 842 includes a set of instructions 842a and heuristics and metadata 842b.

Although the video decoding module 840, the data reception module 841, and the task performance module 842 are illustrated as residing on a single computing device 800, it should be understood that in other embodiments, any combination of the video decoding module 840, the data reception module 841, and the task performance module 842 may reside in separate computing devices. For example, each of the video decoding module 840, the data reception module 841, and the task performance module 842 may reside on a separate computing device.

Moreover, FIGS. 7 and 8 are intended more as functional description of the various features which may be present in a particular embodiment as opposed to a structural schematic of the embodiments described herein. As recognized by those of ordinary skill in the art, items shown separately could be combined and some items could be separated. For example, some functional modules shown separately in FIGS. 7 and 8 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
selecting a first video encoding task of a plurality of video encoding tasks, the first video encoding task having a first dependency upon a second video encoding task of the plurality of video encoding tasks;
determining whether to break the first dependency; and
performing the first video encoding task based on the determination of whether to break the first dependency, wherein the first video encoding task is performed based on a result of performing the second video encoding task in response to determining not to break the first dependency or the first video encoding task is performed independent of the result of performing the second video encoding task in response to determining to break the first dependency.

2. The method of claim 1, wherein at least one of selecting the first video encoding task or determining whether to break the first dependency is performed in order to increase coding efficiency without increasing delay.

3. The method of claim 1, further comprising storing a first result of performing the first video encoding task in association with a first flag indicative of the determination of whether to break the first dependency.

4. The method of claim 3, further comprising:
selecting a third video encoding task of the plurality of video encoding tasks, the third video encoding task having a second dependency upon a fourth video encoding task of the plurality of video encoding tasks;
determining whether to break the second dependency;
performing the third video encoding task based on the determination of whether to break the second dependency; and
storing a second result of performing the third video encoding task in association with a second flag indicative of the determination of whether to break the second dependency.

5. The method of claim 4, further comprising:
transmitting a first message comprising data indicative of the first result and the first flag; and
transmitting a second message comprising data indicative of the second result and the second flag.

6. The method of claim 4, further comprising:
transmitting a first message comprising data indicative of the first flag and the second flag; and
transmitting a second message comprising data indicative of the first result; and
transmitting a third message comprising data indicative of the second result.

7. The method of claim 1, wherein identifying the plurality of video encoding tasks comprises determining an order of the plurality of video encoding tasks, wherein selecting the first video encoding task comprises selecting a next video encoding task in the order.

8. The method of claim 7, wherein determining the order of the plurality of video encoding tasks comprises accessing a non-raster order stored in a memory.

9. The method of claim 7, wherein determining the order of the plurality of video encoding tasks comprises:
determining, for each of the plurality of video encoding tasks, a number of other video encoding tasks having a dependency upon the video encoding task; and
generating the order of the plurality of video encoding tasks based on the numbers.

10. The method of claim 1, wherein selecting the first video encoding task comprises determining that the first video encoding task has no unresolved dependencies.

11. The method of claim 1, wherein selecting the first video encoding task comprises:
determining, for each of the plurality of video encoding tasks, a number of unresolved dependencies had by the video encoding task; and
selecting a video encoding task having a smallest number.

12. The method of claim 1, wherein determining whether to break the first dependency comprises determining to break first dependency in response to determining that the result of performing the second video encoding task is unavailable.

13. The method of claim 1, wherein determining whether to break the first dependency comprises:
determining that the result of performing the second video encoding task is unavailable;
determining to wait for the result of performing the second video encoding task to become available; and
determining not to break the first dependency in response to the result of performing the second video encoding task becoming available.

14. The method of claim 1, wherein determining whether to break the first dependency comprises determining to break the first dependency when the first video encoding task is associated with a first quadrant of a video frame, the second video encoding task is associated with a second quadrant of the video frame, and the first quadrant is different from the second quadrant.

15. An apparatus comprising:
one or more processors;
a non-transitory memory comprising instructions that when executed cause the one or more processors to perform operations including:
selecting a first video encoding task of a plurality of video encoding tasks, the first video encoding task having a first dependency upon a second video encoding task of the plurality of video encoding tasks;
determining whether to break the first dependency; and
performing the first video encoding task based on the determination of whether to break the first dependency, wherein the first video encoding task is performed based on a result of performing the second video encoding task in response to determining not to break the first dependency or the first video encoding task is performed independent of the result of performing the second video encoding task in response to determining to break the first dependency.

16. The apparatus of claim 15, wherein the operations further comprise storing, in the memory, a first result of performing the first video encoding task in association with a first flag indicative of the determination of whether to break the first dependency.

17. The apparatus of claim 15, wherein the operations further comprise determining an order of the plurality of video encoding tasks, wherein selecting the first video encoding task comprises selecting a next video encoding task in the order.

18. The apparatus of claim 15, wherein determining whether to break the first dependency comprises determining to break first dependency in response to determining that the result of performing the second video encoding task is unavailable.

19. A method comprising:
receiving first data indicative of a result of performing a first video encoding task;
receiving second data indicative of a result of performing a second video encoding task;
receiving third data indicative of whether the first video encoding task was performed based on the result of performing the second video encoding task; and
performing, using the first data, a first video decoding task associated with the first video encoding task, wherein the first video decoding task is performed based on the second data in response to the third data indicating that the first video encoding task was performed based on the result of performing the second video encoding task or the first video decoding task is performed independent of the second data in response to the third data indicating that the first video encoding task was not performed based on the result of performing the second video encoding task.

20. The method of claim 19, wherein the third data comprises a first flag received in association with the result of performing the first video encoding task.
